(19) United States
(12) Patent Application Publication
(10) Pub. No.: US 2026/0038968 A1
(43) Pub. Date: Feb. 5, 2026

(54) NONAQUEOUS ELECTROLYTE SECONDARY BATTERY LAMINATED SEPARATOR

(71) Applicant: Sumitomo Chemical Company, Limited, Tokyo (JP)

(72) Inventors: Atsushi Nakazawa, Niihama-shi (JP); Masumi Yamashita, Niihama-shi (JP)

(21) Appl. No.: 19/284,404

(22) Filed: Jul. 29, 2025

(30) Foreign Application Priority Data
Jul. 31, 2024 (JP) 2024-124974

(51) Int. Cl. H01M 50/449; H01M 10/05; H01M 50/417; H01M 50/423

(52) U.S. Cl. CPC H01M 50/449; H01M 10/05; H01M 50/417; H01M 50/423

(57) ABSTRACT

Provided is a nonaqueous electrolyte secondary battery laminated separator which makes it possible to improve the cycle characteristics of a battery which incorporates the separator. A nonaqueous electrolyte secondary battery laminated separator in accordance with the present disclosure includes a polyolefin porous film and a porous layer, and the porous layer is formed on one surface or both surfaces of the polyolefin porous film. The nonaqueous electrolyte secondary battery laminated separator has an average linear expansion coefficient of not less than 3.0×10⁻⁶ [1/K] in the TD direction at 30° C. to 50° C.

This Nonprovisional application claims priority under 35 U.S.C. § 119 on Patent Application No. 2024-124974 filed in Japan on Jul. 31, 2024, the entire contents of which are hereby incorporated by reference.

### TECHNICAL FIELD

The present invention relates to a laminated separator for a nonaqueous electrolyte secondary battery (hereinafter referred to as a “nonaqueous electrolyte secondary battery laminated separator”).

### BACKGROUND ART

Nonaqueous electrolyte secondary batteries, in particular, lithium ion secondary batteries, have a high energy density, and are therefore widely used as batteries intended for personal computers, mobile telephones, portable information terminals, cars, and the like. Typically, lithium ion batteries include a separator between a positive electrode and a negative electrode. For the purpose of improving the functions of batteries, various separators have been proposed (see, for example, Patent Literature 1).

### CITATION LIST

### Patent Literature

### [Patent Literature 1]

Japanese Patent Application Publication, Tokukai, No. 2006-299612

### SUMMARY OF INVENTION

### Technical Problem

The separator as disclosed in Patent Literature 1 is susceptible to improvement in the cycle characteristics of a battery which incorporates the separator.

An object of an aspect of the present invention is to provide a nonaqueous electrolyte secondary battery laminated separator which makes it possible to improve the cycle characteristics of a battery which incorporates the separator.

### Solution to Problem

The present invention include the following aspects.

<1>

A nonaqueous electrolyte secondary battery laminated separator, including:
a polyolefin porous film and a porous layer, the porous layer being formed on one surface or both surfaces of the polyolefin porous film,
the nonaqueous electrolyte secondary battery laminated separator having an average linear expansion coefficient of not less than 3.0×10⁻⁶ [1/K] in a TD direction at 30° C. to 50° C.
   <2>

The nonaqueous electrolyte secondary battery laminated separator described in <1>, in which
the nonaqueous electrolyte secondary battery laminated separator has an average linear expansion coefficient of not less than-8.0×10⁻⁶ [1/K] in an MD direction at 30° C. to 50° C.
   <3>

The nonaqueous electrolyte secondary battery laminated separator described in <1> or <2>, in which
the porous layer includes a filler, and
the filler is an inorganic filler and/or an organic filler.
   <4>

The nonaqueous electrolyte secondary battery laminated separator described in <3>, in which
with respect to 100% by weight of the porous layer, the filler is contained in an amount of 30% by weight to 99% by weight.
   <5>

The nonaqueous electrolyte secondary battery laminated separator described in any one of <1> to <4>, in which
the porous layer includes at least one resin selected from the group consisting of polyolefins, (meth)acrylate-based resins, fluorine-containing resins, polyamide-based resins, polyimide-based resins, polyamide-imide-based resins, polyester-based resins, and water-soluble polymers.
   <6>

The nonaqueous electrolyte secondary battery laminated separator described in <5>, in which
the porous layer includes an aramid resin.
   <7>

A nonaqueous electrolyte secondary battery member, including
a positive electrode, the nonaqueous electrolyte secondary battery laminated separator described in any one of <1> to <6>, and a negative electrode which are formed on top of each other in this order.
   <8>

A nonaqueous electrolyte secondary battery, including the nonaqueous electrolyte secondary battery laminated separator described in any one of <1> to <6>.

<9>

A nonaqueous electrolyte secondary battery, including
the nonaqueous electrolyte secondary battery member described in <7>.

### Advantageous Effects of Invention

As aspect of the present invention provides a nonaqueous electrolyte secondary battery laminated separator which makes it possible to improve the cycle characteristics of a battery which incorporates the separator.

### DESCRIPTION OF EMBODIMENTS

The following description will discuss embodiments of the present invention. The present invention is, however, not limited to such embodiments. Further, the present invention is not limited to the configurations below, but may be altered in various ways by a skilled person within the scope of the claims. Any embodiment obtained by a proper combination of the technical means disclosed in differing embodiments is also within the technical scope of the present invention. The numerical range expression “A to B” means “not less than A and not more than B” unless otherwise noted herein.

As used herein, the “MD (MD direction)” indicates the longitudinal direction of elongated articles that are continuously produced. As used herein, the “TD (TD direction)” indicates a direction of the elongated articles that are continuously produced, the direction being orthogonal to the MD. The MD and the TD are concepts in the production process, and an article produced can exhibit different physical properties in the different directions of MD and TD (e.g., the orientation of constituent components or constituent molecules). On the basis of such physical properties, it is possible to identify the MD and the TD even for a product which has left the production process.

A nonaqueous electrolyte secondary battery laminated separator can be simply referred to as a “separator” herein. The average linear expansion coefficient in the TD direction at 30° C. to 50° C. can be simply referred to as a “TD average linear expansion coefficient” herein. The average linear expansion coefficient in the MD direction at 30° C. to 50° C. can be simply referred to as a “MD average linear expansion coefficient” herein.

### [1. Nonaqueous Electrolyte Secondary Battery Laminated Separator]

### [1.1. Average Linear Expansion Coefficient in TD Direction at 30° C. to 50° C.]

A study conducted by the inventors of the present invention has proved that a separator which has an average linear expansion coefficient adjusted to a certain value or greater in the TD direction at 30° C. to 50° C. is capable of improving the cycle characteristics (including the discharge capacity maintaining rate after cycle) of a battery which incorporates the separator. While not wishing to be bound by any theory, it is believed that since a separator having such characteristics is more likely to expand in the TD direction at a higher temperature in the temperature range (which is typically 30° C. to 50° C.) associated with charging and discharging, the separator suitably changes in shape with the charging and discharging to be able to follow the expansion and contraction of the electrodes, and the cycle characteristics of the battery are improved accordingly.

In order to produce a separator having such characteristics, it is preferable to stretch the separator in the TD direction after formation of a porous layer in the production process. For example, when the separator is stretched at a low degree of stretching in the TD direction after formation of a porous layer, the TD average linear expansion coefficient tends to increase. Further, when the separator is contracted again in the TD direction after this stretching, the TD average linear expansion coefficient tends to further increase. For more specific example, see [3. Method for producing nonaqueous electrolyte secondary battery laminated separator].

It is considered that by performing the TD stretching after formation of a porous layer, residual stress inside the separator caused by the formation of a porous layer is adjusted. Thus, there is the technical significance of performing the TD stretching after formation of a porous layer, and forming a porous layer on one surface or both surfaces of a polyolefin porous film which has undergone the TD stretching in advance is not considered to make it possible to adjust the TD average linear expansion coefficient.

### [1.2. Physical Properties of Separator]

The separator has a TD average linear expansion coefficient of not less than 3.0×10⁻⁶ [1/K]. The TD average linear expansion coefficient can be not less than 5.0×10⁻⁶ [1/K], not less than 10.0×10⁻⁶ [1/K], not less than 20.0×10⁻⁶ [1/K], not less than 40.0×10⁻⁶ [1/K], not less than 50.0×10⁻⁶ [1/K], not less than 75.0×10⁻⁶ [1/K], or not less than 100.0×10⁻⁶ [1/K]. A batter which incorporates the separator satisfying this condition has excellent cycle characteristics. For example, the upper limit of the TD average linear expansion coefficient can be not more than 500.0×10⁻⁶ [1/K] or not more than 250.0× 10⁻⁶ [1/K].

As used herein, the TD average linear expansion coefficient is a value obtained by converting the amount of change in the length of a test piece in the TD direction per degree of temperature, said amount of change being calculated from the gradient of a straight line connecting the respective points on a linear expansion coefficient curve that correspond to 30° C. and 50° C., into the amount of change in the length of the test piece before a test in the TD direction per millimeter of length. The TD average linear expansion coefficient is determined from the following formula.

TD average linear expansion coefficient (1/K)=[{L(T₅₀)−L(T₃₀)}/20]/L₀
L₀: the length (mm) of a test piece in the TD direction before a test L(T₃₀): the amount (mm) of change in the length of the test piece in the TD direction at 30° C.
L(T₅₀): the amount (mm) of change in the length of the test piece in the TD direction at 50° C.

The separator has an MD average linear expansion coefficient which can be not less than −10.0×10⁻⁶ [1/K], not less than −8.0×10^{-6 [1}/K], or not less than −7.0×10⁻⁶ [1/K]. A batter which incorporates the separator satisfying this condition has excellent cycle characteristics. For example, the upper limit of the MD average linear expansion coefficient can be not more than 150.0×10⁻⁶ [1/K] or 100.0× 10⁻⁶ [1/K].

As used herein, the MD average linear expansion coefficient is a value obtained by converting the amount of change in the length of a test piece in the MD direction per degree of temperature, said amount of change being calculated from the gradient of a straight line connecting the respective points on a linear expansion coefficient curve that correspond to 30° C. and 50° C., into the amount of change in the length of the test piece before a test in the MD direction per millimeter of length. The MD average linear expansion coefficient is determined from the following formula.

MD average linear expansion coefficient (1/K)=[{L′(T₅₀)−L′(T₃₀)}/20]/L′₀
L′₀: the length (mm) of a test piece in the MD direction before a test L′(T₃₀): the amount (mm) of change in the length of the test piece in the MD direction at 30° C.
L′(T₅₀): the amount (mm) of change in the length of the test piece in the MD direction at 50° C.

The linear expansion coefficient curve is a graph in which the horizontal axis represents temperatures, and the vertical axis represents linear expansion coefficients of a separator. The linear expansion coefficient curve is determined by a thermomechanical analysis which is based on JIS K7197. For a specific example of the measurement method, see Examples below.

A battery incorporating the separator has a discharge capacity maintaining rate which is preferably not less than 85% and more preferably not less than 90% after undergoing 200 cycles. When the discharge capacity maintaining rate is within the above range, the battery incorporating the separator can be said to have improved cycle characteristics. For a method for measuring the discharge capacity maintaining rate after a cycle test, see Examples below.

The separator has an air permeability which is preferably not more than 500 s/100 mL, more preferably not more than 400 s/100 mL, and even more preferably not more than 300 s/100 mL, in terms of the Gurley value. When the air permeability of the separator is within the above range, the separator can be said to have sufficient ion permeability.

The breakdown voltage of the separator is preferably not less than 1.65 kV/mm, and more preferably not less than 1.70 kV/mm.

The separator has a porosity which is preferably 20% by volume to 80% by volume, more preferably 30% by volume to 70% by volume, and even more preferably 40% by volume to 60% by volume, in order to make it possible to retain a greater amount of an electrolyte and also obtain the function of reliably preventing, at a lower temperature, excessive current from flowing.

### [2. Configuration of Nonaqueous Electrolyte Secondary Battery Laminated Separator]

The separator is a laminated separator which includes a polyolefin porous film and a porous layer, the porous layer being formed on one surface or both surfaces of the polyolefin porous film. When the porous layer is provided on both surfaces of the polyolefin porous film, one of the surfaces may be the same as or differ from the other in the film thickness, the basis weight, the porosity, etc.

### [2.1. Polyolefin Porous Film]

As used herein, the “polyolefin porous film” is a film which contains a polyolefin-based resin as the main component. The phrase “contain a polyolefin-based resin as the main component” means that the polyolefin-based resin is contained in the polyolefin porous film at a proportion which is not less than 50% by weight, preferably not less than 90% by weight, and more preferably not less than 95% by weight, with respect to all the materials that constitute the polyolefin porous film.

The porous substrate contains a polyolefin-based resin as the main component, and has therein many pores connected to one another. This allows a gas and a liquid to pass through the polyolefin porous film from one side to the other side.

The polyolefin preferably contains a high molecular weight component which has a weight-average molecular weight of 5×10⁵ to 15×10⁶. In particular, the polyolefin more preferably has the high molecular weight component which has a weight-average molecular weight of not less than 1,000,000, because the strength of the nonaqueous electrolyte secondary battery laminated separator in accordance with an embodiment of the present invention improves.

Examples of the polyolefin include a homopolymer or a copolymer which is obtained by polymerizing a monomer(s) such as ethylene, propylene, 1-butene, 4-methyl-1-pentene, and/or 1-hexene.

Examples the homopolymer include polyethylene, polypropylene, and polybutene. Examples of the copolymer include an ethylene-propylene copolymer.

Among these examples, the polyolefin is preferably polyethylene because it is possible to prevent, at a lower temperature, excessive current from flowing. Note that this “preventing excessive current from flowing” is also referred to as “shutdown”.

Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these examples, the polyethylene is even more preferably ultra-high molecular weight polyethylene having a weight-average molecular weight of not less than 1,000,000.

The basis weight of the polyolefin porous film can be determined as appropriate in consideration of the strength, the film thickness, the weight, and handleability. Further, the basis weight is preferably 2 g/m² to 20 g/m², more preferably 2 g/m² to 12 g/m², and even more preferably 3 g/m² to 10 g/m², in order to make it possible to increase the weight energy density and the volume energy density of the nonaqueous electrolyte secondary battery.

The polyolefin porous film has an air permeability which is preferably 30 s/100 mL to 500 s/100 mL, and more preferably 50 s/100 mL to 300 s/100 mL, in terms of the Gurley value. The polyolefin porous film having the air permeability in the above range makes it possible to impart sufficient ion permeability to the polyolefin porous film.

The polyolefin porous film has a porosity which is preferably 20% by volume to 80% by volume, and more preferably 30% by volume to 75% by volume, in order to make it possible to retain a greater amount of an electrolyte and also obtain the function of reliably preventing, at a lower temperature, excessive current from flowing.

The polyolefin porous film has pores each having a pore diameter which is preferably not more than 0.3 μm, and more preferably not more than 0.14 μm, in order to make it possible to obtain sufficient ion permeability and prevent particles from entering the positive electrode and the negative electrode.

The lower limit of the film thickness of the polyolefin porous film is preferably not less than 4 μm, more preferably not less than 5 μm, and even more preferably not less than 6 μm. The upper limit of the film thickness of the polyolefin porous film is preferably not more than 29 μm, more preferably not more than 20 μm, and even more preferably not more than 15 μm.

The polyolefin porous film may have a multilayer structure of not less than two layers. Examples of the polyolefin porous film that has a multilayer structure include a film in which a layer which contains polyethylene as the main component and a layer which contains polypropylene as the main component are formed on top of each other. The number of layers to be contained in the multilayer structure is not particularly limited. For example, the multilayer structure may be a two-layer structure of a polyethylene layer and a polypropylene layer, or may be a three-layer structure in which at least one polyethylene layer and at least one polypropylene layer are combined. The multilayer structure of a polyethylene layer and a polypropylene layer makes it possible to achieve the shutdown property and heat resistance at the same time.

The polyolefin porous film may have a crosslinked structure. The crosslinked structure can be introduced by, for example, using a silane-modified polyolefin. The polyolefin porous film having the crosslinked structure has excellent heat resistance. Thus, by combining the polyolefin porous film having the crosslinked structure with a porous layer, it is possible to further improve the heat resistance of the nonaqueous electrolyte secondary battery laminated separator. Note that the crosslinked structure may be formed between the polyolefin porous film and the porous layer.

### [2.2. Porous Layer]

Typically, the porous layer includes a binder resin. The binder resin is preferably a resin which is insoluble in the electrolyte of a battery, and is electrochemically stable under the use conditions for the battery. In an embodiment, the porous layer includes a filler in addition to the binder resin.

### (Binder Resin)

Examples of said resin include: polyolefins; (meth)acrylate-based resins; aromatic resins; fluorine-containing resins; polyamide-based resins; polyimide-based resin; polyamide-imide-based resins; polyester-based resins; rubbers; resins having melting points or glass transition temperatures of not less than 180° C.; water-soluble polymers; polycarbonates; polyacetals; and polyetheretherketone.

Among these resins, at least one resin selected from the group consisting of polyolefins, (meth)acrylate-based resins, fluorine-containing resins, aromatic resins, polyamide-based resins, polyester-based resins, polyamide-imide-based resins, and water-soluble polymers is preferable.

As said resin, aromatic resins are more preferable. Among aromatic resins, nitrogen-containing aromatic resins are particularly preferable. Further, among nitrogen-containing aromatic resins, aramid resins (described later) are most preferable. Nitrogen-containing aromatic resins contain a bond formed via nitrogen, such as an amide bond, and therefore have excellent heat resistance. Thus, said resin being a nitrogen-containing aromatic resin makes it possible to suitably improve the heat resistance of the porous layer. As a result, it is possible to improve the heat resistance of a nonaqueous electrolyte secondary battery laminated separator which includes the porous layer.

The polyolefin is preferably polyethylene, polypropylene, polybutene, an ethylene-propylene copolymer, or the like.

Examples of the fluorine-containing resins can include polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkylvinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins include fluorine-containing rubber having a glass transition temperature of not more than 23° C.

The polyamide-based resins are preferably polyamide-based resins which fall under nitrogen-containing aromatic resins, and particularly preferably aramid resins such as an aromatic polyamide and a wholly aromatic polyamide.

Examples of the aramid resins include poly(paraphenylene terephthalamide), poly(methaphenylene isophthalamide), poly(parabenzamide), poly(metabenzamide), poly(4,4′-benzanilide terephthalamide), poly(paraphenylene-4,4′-biphenylene dicarboxylic acid amide), poly(methaphenylene-4,4′-biphenylene dicarboxylic acid amide), poly(paraphenylene-2,6-naphthalene dicarboxylic acid amide), poly(methaphenylene-2,6-naphthalene dicarboxylic acid amide), poly(2-chloroparaphenylene terephthalamide), a paraphenylene terephthalamide/2,6-dichloroparaphenylene terephthalamide copolymer, a methaphenylene terephthalamide/2,6-dichloroparaphenylene terephthalamide copolymer, poly(4,4′-diphenylsulfonyl terephthalamide), and a paraphenylene terephthalamide/4,4′-diphenylsulfonyl terephthalamide copolymer.

Among said aramid resins, at least one selected from the group consisting of poly(paraphenylene terephthalamide) and paraphenylene terephthalamide/4,4′-diphenylsulfonyl terephthalamide copolymer is preferable, since these aramid resins are easy to produce and easy to handle.

The polyester-based resins are preferably aromatic polyesters such as polyarylates and liquid crystal polyesters.

Examples of the rubbers can include a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate.

Examples of the resins having melting points or glass transition temperatures of not less than 180° C. can include polyphenylene ether, polysulfones, polyether sulfones, polyphenylene sulfide, polyetherimide, polyamide-imides, and polyether amides.

The polyamide-imides are preferably aromatic polyamide-imides. Examples of the aromatic polyamide-imides include a wholly aromatic polyamide-imide and a semi-aromatic polyamide-imide. The aromatic polyamide-imides are preferably wholly aromatic polyamide-imides.

Examples of the water-soluble polymers can include polyvinyl alcohol, polyethylene glycol, cellulose ether, sodium alginate, polyacrylic acid, polyacrylamide, and polymethacrylic acid.

Note that as said resin, one type of resin may be used singly, or two or more types of resins may be used in combination. For example, by using a polyamide-based resin having excellent heat resistance in combination with a (meth)acrylate-based resin and/or a fluorine-containing resin which have adhesion, it is possible to obtain a porous layer which has heat resistance and adhesion at the same time. In this respect, the form in which the (meth)acrylate-based resin and/or the fluorine-containing resin is/are present is not particularly limited. For example, these resins may be in the form of particles, may be present so as to be mixed with a polyamide-based resin, or may be localized to the surface of the porous layer. The amount of the resin contained in the porous layer is preferably 25% by weight to 80% by weight, and more preferably 30% by weight to 70% by weight, with respect to 100% by weight of the porous layer.

### (Filler)

The material of the filler is not particularly limited. The filler may be composed only of a filler which consists of one type of material, or may be composed of two or more different types of fillers which consist of different materials. The filler can be an inorganic filler or an organic filler.

Examples of the inorganic filler can include a filler consisting of an inorganic substance such as calcium carbonate, talc, clay, kaolin, silica, hydrotalcite, diatom earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, or glass. In particular, the inorganic filler is preferably a filler consisting of an inorganic oxide such as silica, calcium oxide, magnesium oxide, titanium oxide, alumina, mica, zeolite, aluminum hydroxide, magnesium hydroxide, barium sulfate, or boehmite, more preferably a filler consisting of calcium oxide, magnesium oxide, magnesium hydroxide, barium sulfate, alumina, or boehmite, and even more preferably a filler consisting of magnesium hydroxide, barium sulfate, alumina, or boehmite.

Examples of the organic filler include: a homopolymer of a monomer such as styrene, vinyl ketone, acrylonitrile, methyl methacrylate, ethyl methacrylate, glycidyl methacrylate, glycidyl acrylate, or methyl acrylate or a copolymer of two or more of such monomers; fluorine-based resins such as polytetrafluoroethylene, an ethylene tetrafluoride-propylene hexafluoride copolymer, an ethylene tetrafluoride-ethylene copolymer, and polyvinylidene fluoride; melamine resins; urea resins; polyolefins; and polymethacrylates. As the organic filler, the above organic fillers may be used singly, or a mixture of two or more of the above organic fillers may be used. Among these organic fillers, polytetrafluoroethylene is preferable in terms of chemical stability. In terms of improving the shutdown property of the nonaqueous electrolyte secondary battery laminated separator, polyolefins are preferable. When polyolefins are used as an organic filler, it is possible to impart the shutdown property to the porous layer.

The filler can be, for example, globular, oval, plate-shaped, rod-shaped, and indefinite in shape, and is not limited to a particular shape. In particular, the filler is preferably globular.

The filler has an average particle diameter which is preferably not less than 0.01 μm and not more than 10 μm, and more preferably not less than 0.02 μm and not more than 5 μm. The filler having an average particle diameter of not less than 1 μm has the following advantages: (i) because the pore diameters of the pores in the porous layer are easy to make greater, ion permeability is less likely to decrease even if a separator is compressed in a battery and (ii) because irregularities are easy to form on the surface of a porous layer, it is possible to improve the sliding properties of a separator. The filler having an average particle diameter of less than 1 μm has the advantage of improving the heat resistance of a separator or making it possible to make a separator thinner. In order to provide these advantages at the same time, two or more types of fillers with different average particle diameters may be used, or a filler with a broad particle size distribution may be used. As used herein, “the average particle diameter of a filler” means the volume-based average particle diameter (D50) of a filler. D50 means the particle diameter of a value which corresponds to 50% in a volume-based cumulative distribution. For example, the D50 can be measured with use of a laser diffraction particle size analyzer (product names: SALD2200, SALD2300, etc., manufactured by Shimadzu Corporation).

The upper limit of the of the filler contained in the porous layer is preferably not more than 99% by weight, more preferably not more than 90% by weight, even more preferably not more than 80% by weight, and particularly preferably not more than 70% by weight, with respect to 100% by weight of the total weight of the porous layer. When the amount of the filler contained satisfies this range, the weight of the porous layer can be adjusted in a proper range. The lower limit of the amount of the filler contained in the porous layer is preferably not less than 30% by weight, and more preferably not less than 40% by weight. When the amount of the filler contained satisfies this range, functions including heat resistance are easily exerted sufficiently.

The basis weight, i.e., the weight per unit area, of one surface of the porous layer can be determined as appropriate in consideration of the strength, the film thickness, the weight, and handleability of the porous layer. The upper limit of the basis weight of the porous layer is preferably not more than 3.0 g/m², more preferably not more than 2.5 g/m², and even more preferably not more than 2.0 g/m². The lower limit of the basis weight of one surface of the porous layer is not particularly limited, but is preferably not less than 0.4 g/m², more preferably not less than 0.45 g/m², and even more preferably not less than 0.5 g/m².

The porous layer has an air permeability which is preferably 30 s/100 mL to 50 s/100 mL, and more preferably 40 s/100 mL to 75 s/100 mL, in terms of the Gurley value. When the air permeability of the porous layer is in the above range, the porous layer can be said to have sufficient ion permeability.

The porosity of the porous layer is preferably 20% by volume to 90% by volume, and more preferably 30% by volume to 50% by volume, in order to make it possible to obtain sufficient ion permeability.

In addition, the pore diameters of the pores of the porous layer are preferably not more than 1.0 μm, and more preferably not more than 0.5 μm. By setting the pore diameters of the pores in these sizes, it is possible to impart sufficient ion permeability to the nonaqueous electrolyte secondary battery which includes the porous layer.

The lower limit of the film thickness of the porous layer is preferably not less than 0.1 μm, more preferably not less than 0.3 μm, and even more preferably not less than 0.5 μm. The upper limit of the film thickness of the porous layer is preferably not more than 20 μm, more preferably not more than 10 μm, and even more preferably not more than 5 μm. When the film thickness of the porous layer is in the above range, it is possible for the porous layer to sufficiently exert the functions (including impartation of heat resistance) and it is possible to reduce the thickness of the entire separator.

The porous layer may contain a component other than the resin and the filler, to an extent that does not compromise the object of the present invention. Examples of said component include an additive commonly used in a nonaqueous electrolyte secondary battery separator. Said component may be of one type, or may be a mixture of two or more types.

Examples of said additive include a flame retardant, an antioxidant, a surfactant, an antistatic agent, a crosslinker, and a wax. The addition of an antistatic agent makes it possible to reduce the opportunity for even a porous layer which is easily electrically charged to bear electrical charges. In addition, the addition of a flame retardant and/or a crosslinker makes it possible to further enhance the safety and heat resistance of the separator.

### [2.3. Other Layers]

The laminated separator may additionally have other layers which are different from the polyolefin porous film and the porous layer, to an extent that does not compromise the object of the present invention. The other layers are not particularly limited, but examples thereof include publicly known layers. Specific examples of the other layers include: an adhesive layer; a heat-resistant porous layer which differs from the porous layer; a slippery layer intended to improve the sliding properties of a separator; a layer which includes organic particles of a polyolefin or the like and which is intended to impart the shutdown property; an antistatic layer, and a protective layer. The heat-resistant porous layer which differs from the porous layer indicates a layer which differs from the porous layer in at least one of the elements such as the type of resin or filler and the filler content. When the other layers includes the heat-resistant porous layer which differs from the porous layer, the type of resin or filler contained in this heat-resistant porous layer and the filler content may be the same as those described in the section on the porous layer. The slippery layer may be a layer which contains an antiblocking agent and/or a filler, and providing irregularities on the surface thereof makes it possible to improve the sliding properties of the separator.

The other layers can be provided on one surface or both surfaces of the laminated separator. When the laminated separator includes a porous layer on both surfaces of the polyolefin porous film, the other layers may be provided on both of the porous layers, or may be provided only on one of the porous layers. When the laminated separator includes a porous layer only on one surface of the polyolefin porous film, the other layers may be provided on the porous layer, may be provided on a surface of the polyolefin porous film that is not provided with the porous layer, or may be provided on both the porous layer and the surface. The other layers can be provided on the outermost layer of the laminated separator.

As used herein, the adhesive layer means a layer having adhesion. The adhesive layer can be provided on the surfaces of the laminated separator that are in contact with the electrodes. Examples of a component of the adhesive layer that contributes to the adhesion include an acrylic resin and a PVDF resin. As the acrylic resin, for example, acrylic resins described in paragraphs to of Japanese Patent Application Publication, Tokukai, 2024-006988 can be used. As the PVDF resin, for example, PVDF resins described in paragraphs to of Japanese Patent Application Publication, Tokukai, 2017-168419 can be used. As the acrylic resin and the PVDF resin, the acrylic resins and the PVDF resins may each be used singly, or two or more of the acrylic resins may be used in combination and two or more of the PVDF resins may be used in combination. The adhesive layer may further include a filler in addition to the component that contributes to the adhesion. As the filler, the same filler that can be used for the porous layer can be used. The form in which the adhesive layer is present is not particularly limited, but the component that contributes to the adhesion may be present in the form of particles, or may be present as a homogeneous coating layer. In addition, the adhesive layer may be formed into the shape of a dot or into the shape of a stripe by pattern coating. When the adhesive layer is provided, the separator is fixed to the electrodes via the adhesive layers. It is therefore possible to improve the handleability and heat resistance of the electrode laminate. When the adhesive layer with said form of particles, said shape of a dot, or said shape of a stripe is provided, it is possible to suppress a decrease in ion permeability due to the provision of the adhesive layer.

### [3. Method for Producing Nonaqueous Electrolyte Secondary Battery Laminated Separator]

### [3.1. Factors in Adjusting TD Average Linear Expansion Coefficient]

Examples of production conditions for making the TD average linear expansion coefficient of the separator not less than 3.0×10⁻⁶ [1/K] include stretching and contraction after formation of the porous layer. Typically, when the stretch ratio of the TD stretching is greater, the TD average linear expansion coefficient tends to be greater. Further, when TD contraction is further carried out after the TD stretching, the TD average linear expansion coefficient tends to be greater.

The stretch ratio of the TD stretching is preferably not less than 0.5%, more preferably not less than 1%, even more preferably not less than 5%, and particularly preferably not less than 10%. The upper limit of the stretch ratio of the TD stretching can be not more than 20% or not more than 15%. When the stretch ratio is as low as in the above range, the porous layer that has been stretched by the stretching is prevented from breaking. As used herein, the phrase “the stretch ratio is X %” is intended to mean that when the length before stretching is 100%, the length after the stretching is (100+X) %.

The contraction ratio of the TD contraction is typically equal to or smaller than the stretch ratio of the TD stretching, and is preferably not more than 8%, more preferably not more than 6%, and even more preferably not more than 4%. As used herein, the phrase “the contraction ratio is X %” is intended to mean that when the length before contraction is 100%, the length after the contraction is (100−X) %.

The above numerical ranges of suitable production conditions are presented by way of example. A person skilled in the art can set, as appropriate, the TD stretching conditions and the TD contraction conditions to adjust the TD average linear expansion coefficient to not less than 3.0×10⁻⁶ [1/K]. As a result, even under production conditions that do not satisfy at least one of the above suitable conditions, a separator which has a TD average linear expansion coefficient of not less than 3.0×10⁻⁶ [1/K] can be obtained.

### [3.2. Factors in Adjusting MD Average Linear Expansion Coefficient]

The MD average linear expansion coefficient of the separator can be adjusted by the same means that are used for the TD average linear expansion coefficient. For example, through stretching and contraction after formation of the porous layer, it is possible to produce a separator having an MD average linear expansion coefficient which falls within a suitable range.

### [3.3. Method for Producing Polyolefin Porous Film]

Examples of a method for producing a polyolefin porous film include the following method. Specifically, first of all, a polyolefin-based resin, a pore forming agent such as an inorganic filler or a plasticizer, and optionally an antioxidant or the like are mixed together, and a polyolefin-based resin composition is obtained accordingly. Subsequently, by extruding the polyolefin-based resin composition, the sheet-shaped polyolefin-based resin composition is produced. The pore forming agent is then removed from the sheet-shaped polyolefin-based resin composition with a proper solvent. Subsequently, by stretching the polyolefin-based resin composition from which the pore forming agent has been removed, it is possible to produce a polyolefin porous film.

The inorganic filler is not particularly limited, but examples thereof include a filler, which is specifically calcium carbonate or the like. The plasticizer is not particularly limited, but examples thereof include a hydrocarbon having a low molecular weight, such as a liquid paraffin.

Examples of a method for producing a polyolefin porous film include a method which includes the following steps.

(i) The step of obtaining a polyolefin-based resin composition by mixing an ultra-high molecular weight polyethylene having a weight-average molecular weight of not less than 1,000,000, a low molecular weight polyethylene having a weight-average molecular weight of not more than 10,000, a pore forming agent such as calcium carbonate or a plasticizer, and an antioxidant are mixed together. (ii) The step of cooling the resultant polyolefin-based resin composition stepwise to form a sheet. (iii) The step of removing the pore forming agent from the resultant sheet with a proper solvent. (iv) The step of stretching, at a proper stretch ratio, the sheet from which the pore forming agent has been removed.

### [3.4. Method for Producing Porous Layer]

A porous layer can be formed with use of a coating solution in which the resin described in [2. Configuration of nonaqueous electrolyte secondary battery laminated separator] is dissolved or dispersed in a solvent. In addition to the dissolving or dispersing of the resin in a solvent, with use of the coating solution obtained by dispersing a filler, the porous layer containing the resin and the filler can be formed.

Note that the solvent can be a solvent in which to dissolve the resin. The solvent can also be a dispersion medium in which to disperse the resin or the filler. Examples of a method for forming the coating solution include a mechanical stirring method, an ultrasonic dispersion method, a high-pressure dispersion method, and a media dispersion method.

Examples of a method for forming the porous layer include: a method of applying the coating solution directly to a surface of the polyolefin porous film and then removing the solvent; a method of applying the coating solution to a proper support and then removing the solvent to form a porous layer, pressure-bonding the porous layer to the polyolefin porous film, and subsequently peeling the support off; a method of applying the coating solution to a surface of a proper support and then pressure-bonding the polyolefin porous film to the surface, and subsequently peeling the support off and then removing the solvent; and a method of carrying out dip coating by immersing the polyolefin porous film into the coating solution, and then removing the solvent.

The solvent is preferably a solvent which does not adversely affect the polyolefin porous film and in which the resin is dissolved uniformly and stably and the filler is disperse uniformly and stably. Examples of the solvent include at least one solvent selected from the group consisting of N-methyl-2-pyrrolidone, N,N-dimethylacetamide, N,N-dimethylformamide, acetone, and water.

The coating solution may include, as appropriate, a component other than the resin and the filler, such as a dispersant, a plasticizer, a surfactant, a pH adjuster, or the like.

As a method for applying the coating solution to the polyolefin porous film, a conventionally publicly known method can be used, and specific examples of such a method include a gravure coater method, a dip coater method, a bar coater method, and a die coater method.

When the coating solution includes an aramid resin, the aramid resin can be precipitated by introducing humidity to a surface to which the coating solution is applied. The porous layer may be formed in this manner.

Examples of a method for removing the solvent from the coating solution which has been applied to a polyolefin porous film can include a method of removing a solvent from the coating film, which is a film of the coating solution, through draft drying and heat drying.

In addition, by changing the amount of the solvent in the coating solution, it is possible to adjust the porosity and the average pore diameter of the resultant porous layer.

The suitable solid content concentration of the coating solution can vary according to the type of filler, etc. Typically, said suitable solid content concentration is preferably not more than 3% by weight and not more than 40% by weight.

The coating shear rate in applying the coating solution to polyolefin porous film can vary according to the type of filler, etc. Typically, said coating shear rate is preferably not less than 2 (1/s), and more preferably 4 (1/s) to 50 (1/s).

### [4. Nonaqueous Electrolyte Secondary Battery Member and Nonaqueous Electrolyte Secondary Battery]

A member for a nonaqueous electrolyte secondary battery (hereinafter referred to as a “nonaqueous electrolyte secondary battery member”) in accordance with an aspect of the present invention includes a positive electrode, the separator described above, and a negative electrode which are disposed in this order. A nonaqueous electrolyte secondary battery in accordance with an aspect of the present invention includes the separator described above or the nonaqueous electrolyte secondary battery member described above.

The nonaqueous electrolyte secondary battery is not limited to a particular shape, but may have the shape of a thin-plate (paper), a disk, a cylinder, a prism such as a cuboid, or the like. The nonaqueous electrolyte secondary battery is a nonaqueous electrolyte secondary battery which generates electromotive force through, for example, the doping and dedoping for adding or removing lithium, and includes a nonaqueous electrolyte secondary battery member which includes a positive electrode, the separator described above, and a negative electrode that are formed on top of each other in this order. Note that the components of the nonaqueous electrolyte secondary battery except the separator described above are not limited to the components described below.

Typically, the nonaqueous electrolyte secondary battery has a structure in which a battery element is encapsulated in an outer packaging material. The battery element has an electrolyte impregnated in a structure in which a negative electrode and a positive electrode face each other via the separator described above. Note that the term “doping” means storage, support, adsorption, or insertion, and means the phenomenon in which lithium ions enter the active material of an electrode such as a positive electrode.

The nonaqueous electrolyte secondary battery member, which includes the separator described above, makes it possible to, when incorporated into a nonaqueous electrolyte secondary battery, suppress the generation of micro short circuits in the nonaqueous electrolyte secondary battery and improve the safety of said battery. In addition, in the nonaqueous electrolyte secondary battery, which includes the separator described above, the generation of micro short circuits is suppressed, and the nonaqueous electrolyte secondary battery has excellent safety.

### [4.1. Positive Electrode]

The positive electrode is not particularly limited, provided that the positive electrode is a commonly-used positive electrode of an electrochemical device. For example, as the positive electrode, a positive electrode sheet can be used which has a structure in which an active material layer that contains a positive electrode active material and a binding agent is formed on a positive electrode current collector. The active material layer may further contain an electrically conductive agent.

Examples of the positive electrode active material include a material capable of being doped and dedoped so that metal ions such as lithium ions or sodium ions are added or removed. Specific examples of said material include a lithium-containing complex metal oxide which contains lithium (Li) and at least one transition metal selected from the group consisting of V, Cr, Mn, Fe, Co, Ni, Cu, and Al. Examples of such a lithium-containing complex metal oxide include LiCoO₂, LiNiO₂, LiMn₂O₄, Li₂MnO₃, LiNiₓMn_{y}Co_{1-x-y}O₂ [0<x+y<1], LiNiₓCo_{y}Al_{1-x-y}O₂ [0<x+y<1], LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄

Examples of the electrically conductive agent include carbonaceous materials such as natural graphite, artificial graphite, cokes, carbon black (e.g., acetylene black), pyrolytic carbons, fibrous carbon materials, and fired products of organic polymer compounds. As the electrically conductive agent, the above carbonaceous materials may be used singly, or two or more of the carbonaceous materials may be used in combination. The proportion of the electrically conductive agent in a positive electrode mix is preferably not less than 5 parts by mass and not more than 20 parts by mass with respect to 100 parts by mass of the positive electrode active material. Said proportion can be reduced when a fibrous carbon material such as graphitized carbon fiber or a carbon nanotube is used as the electrically conductive agent.

As said binding agent, a thermoplastic resin can be used. Examples of the thermoplastic resin include: fluorine-based resins such as PVdF, polytetrafluoroethylene (PTFE), an ethylene tetrafluoride-propylene hexafluoride-vinylidene fluoride-based copolymer, a propylene hexafluoride-vinylidene fluoride-based copolymer, and an ethylene tetrafluoride-perfluorovinyl ether-based copolymer; acrylic resins; styrene butadiene rubber; polyimide resins; and polyolefin resins. Note that the binding agent also has the function of a thickener. A mixture of two or more of these thermoplastic resins may be used. A positive electrode mix that has both strong force of adhesion to the positive electrode current collector and strong force of binding inside the positive electrode mix can be obtained by using a fluorine resin and a polyolefin resin as a binder to adjust the ratio of the fluorine-based resin to the entire positive electrode mix to not less than 1% by mass and not more than 10% by mass and adjust the ratio of the polyolefin resin to the entire positive electrode mix to not less than 0.1% by mass and not more than 2% by mass.

Examples of the positive electrode current collector include electric conductors such as Al, Ni, and stainless steel. Among these electric conductors, Al is more preferable because Al is easily processed into a thin film and is inexpensive.

Examples of a method for producing the positive electrode sheet include: a method of pressure-molding the positive electrode active material, the electrically conductive agent, and the binding agent (positive electrode mix) on the positive electrode current collector; and a method of using a proper organic solvent to form the positive electrode mix into a paste, then coating the positive electrode current collector with the paste and drying the paste, and then applying pressure to cause the paste to firmly adhere to the positive electrode current collector.

Examples of the organic solvent that can be used in the above method include: amine-based solvents such as N,N-dimethylaminopropylamine and diethylenetriamine; ether-based solvents such as tetrahydrofuran; ketone-based solvents such as methyl ethyl ketone; ester-based solvents such as methyl acetate; and amide-based solvents such as dimethylacetamide and NMP.

Examples of a method of coating the positive electrode current collector with the paste of the positive electrode mix include a slit-die coating method, a screen coating method, a curtain coating method, a knife coating method, a gravure coating method, and an electrostatic spray method.

### [4.2. Negative Electrode]

The negative electrode is not particularly limited, provided that the negative electrode is a commonly-used negative electrode of an electrochemical device. For example, as the negative electrode, a negative electrode sheet can be used which has a structure in which an active material layer that contains a negative electrode active material and a binding agent is formed on a negative electrode current collector. The active material layer may further contain an electrically conductive agent.

Examples of the negative electrode active material include a material capable of being doped and dedoped so that metal ions such as lithium ions or sodium ions are added or removed. Examples of the material include materials such as carbonaceous materials, chalcogen compounds (such as oxides and sulfides), nitrides, and metals or alloys which each are capable of being doped and dedoped so that lithium ions are added or removed at electric potentials lower than that of the positive electrode. Examples of carbonaceous materials include natural graphite, artificial graphite, cokes, carbon black, and pyrolytic carbons.

Examples of the oxides that can be used as the negative electrode active material include: oxides of silicon which are represented by a formula SiOₓ (where x is a positive real number), such as SiO₂ and SiO; oxides of titanium which are represented by a formula TiOₓ (where x is a positive real number), such as TiO₂ and TiO; oxides of vanadium which are represented by a formula VOₓ (where x is a positive real number), such as V₂O₅ and VO₂; oxides of iron which are represented by a formula FeOₓ (where x is a positive real number), such as Fe₃O₄, Fe₂O₃, and FeO; oxides of tin which are represented by a formula SnOx (where x is a positive real number), such as SnO₂ and SnO; oxides of tungsten which are represented by a formula WOₓ (where x is a positive real number), such as WO₃ and WO₂; and complex metal oxides which contain lithium, and titanium or vanadium, such as Li₄Ti₅O₁₂ and LiVO₂.

Examples of the sulfides that can be used as the negative electrode active material include: sulfides of titanium which are represented by a formula TiSₓ (where x is a positive real number), such as Ti₂S₃, TiS₂, and TiS; sulfides of vanadium which are represented by a formula VSₓ (where x is a positive real number), such as V₃S₄, VS₂, and VS; sulfides of iron which are represented by a formula FeSₓ (where x is a positive real number), such as Fe₃S₄, FeS₂, and FeS; sulfides of molybdenum which are represented by a formula MoSₓ (where x is a positive real number), such as Mo₂S₃ and MoS₂; sulfides of tin which are represented by a formula SnSx (where x is a positive real number), such as SnS₂ and SnS; sulfides of tungsten which are represented by a formula WSₓ (where x is a positive real number), such as WS₂; sulfides of antimony which are represented by a formula SbSₓ (where x is a positive real number), such as Sb₂S₃; and sulfides of selenium which are represented by a formula SeSₓ (where x is a positive real number), such as Se₅S₃, SeS₂, and SeS.

Examples of the nitrides that can be used as the negative electrode active material include lithium-containing nitrides such as Li₃N and Li₃₋ₓAₓN (where A is one or both of Ni and Co, and 0<x<3).

One type of substance from among these carbonaceous materials, oxides, sulfides, and nitrides may be used alone, or two or more types of substances from among these carbonaceous materials may be used in combination. These carbonaceous materials, oxides, sulfides, and nitrides may be either crystalline or amorphous.

Examples of the metals that can be used as the negative electrode active material include lithium metals, silicon metals, and tin metals.

Examples of the alloys that can be used as the negative electrode active material include lithium alloys such as Li—Al, Li—Ni, Li—Si, Li—Sn, and Li—Sn—Ni; silicon alloys such as Si—Zn; tin alloys such as Sn—Mn, Sn—Co, Sn—Ni, Sn—Cu, and Sn—La; and alloys such as Cu₂Sb and La₃ Ni₂Sn₇.

These metals and alloys are each mainly solely used as an electrode after being processed into foil, for example. Among the above negative electrode active materials, a carbonaceous material that contains, as the main component, graphite such as natural graphite or artificial graphite is preferably used. This is because, with such a carbonaceous material, the electric potential of a negative electrode varies little (good potential flatness) from an uncharged state to a fully charged state during charging, the average discharge potential is low, and the capacity maintenance ratio (good cycle characteristics) when charging and discharging are repeatedly carried out is high. The carbonaceous material may have any of the shapes of: a flake like natural graphite; a sphere like mesocarbon microbeads; a fiber like graphitized carbon fiber; and an aggregate of fine powders, for example.

Examples of the negative electrode current collector include Cu, Ni, and stainless steel. In particular, Cu is more preferable because Cu is not easily alloyed with lithium and is easily processed into a thin film.

Examples of a method for producing the negative electrode sheet include: a method of pressure-molding the negative electrode active material on the negative electrode current collector; and a method of using a proper organic solvent to form the negative electrode active material into a paste, then coating the negative electrode current collector with the paste and drying the paste, and then applying pressure to cause the paste to firmly adhere to the negative electrode current collector. The paste preferably contains any of the above electrically conductive agents and any of the above binding agents.

The negative electrode sheet may contain a binder, as necessary. Examples of the binder can include a thermoplastic resin, specific examples of which include PVdF, thermoplastic polyimides, carboxymethyl cellulose, and polyolefin resins.

### [4.3. Nonaqueous Electrolyte]

The nonaqueous electrolyte is not particularly limited, provided that the nonaqueous electrolyte is a commonly-used nonaqueous electrolyte of an electrochemical device, which is, for example, a nonaqueous electrolyte secondary battery. Examples of the nonaqueous electrolyte include a nonaqueous electrolyte which is obtained by dissolving a lithium salt in an organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, LiN(SO₂C₂F₅)₂, LiN(SO₂CF₃)(COCF₃), Li(C₄F₉SO₃), Li₂B₁₀Cl₁₀, LiBOB (where refers to BOB bis(oxalato)borate), LIFSI (where FSI refers to bis(fluorosulfonyl)imide), lower aliphatic carboxylic acid lithium salt, and LiAlCl₄. As the lithium salt, the above lithium salts may be used singly, or two or more of the lithium salts may be used in combination. As the electrolyte, in particular, it is preferable to use at least one fluorine-containing lithium salt selected from the group consisting of LiPF₆, LiAsF₆, LiSbF₆, LiBF₄, LiCF₃SO₃, LiN(SO₂CF₃)₂, and LiC(SO₂CF₃)₃.

Examples of the organic solvent include: carbonates such as propylene carbonate, ethylene carbonate, dimethyl carbonate, diethyl carbonate, ethyl methyl carbonate, 4-trifluoromethyl-1,3-dioxolane-2-on, and 1,2-di(methoxy carbonyloxy) ethane; ether such as 1,2-dimethoxyethane, 1,3-dimethoxypropane, pentafluoropropyl methylether, 2,2,3,3-tetrafluoropropyl difluoromethylether, tetrahydrofuran, or 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and these solvents further having a fluoro group introduced therein (i.e., these solvents having at least one of the hydrogen atoms substituted with a fluorine atom). As the organic solvent, the above organic solvents may be used singly, or two or more of the above organic solvents may be used in combination. In particular, a mixed solvent containing a carbonate is preferable, and a mixed solvent of a cyclic carbonate and an acyclic carbonate and a mixed solvent of a cyclic carbonate and ether is even more preferable. The mixed solvent containing a cyclic carbonate and an acyclic carbonate is preferably a mixed solvent containing ethylene carbonate, dimethyl carbonate, and ethyl methyl carbonate. The electrolyte obtained with use do such a mixed solvent has many advantages of having a wide operating temperature range, being less prone to deterioration even when subjected to charging and discharging at a high current rate, being less prone to deterioration even when used for a long period of time, and being less prone to decomposition even when the negative electrode active material is a graphite material such as natural graphite or artificial graphite.

### [4.4. Method for Producing Nonaqueous Electrolyte Secondary Battery]

As a method for producing the nonaqueous electrolyte secondary battery, a conventionally publicly known production method can be adopted. For example, by disposing a positive electrode, the separator described above, and a negative electrode in this order, a nonaqueous electrolyte secondary battery member is formed. Then, the nonaqueous electrolyte secondary battery member is put into a container which serves as the housing for the nonaqueous electrolyte secondary battery. Further, the container is filled with a nonaqueous electrolyte, and then sealed under reduced pressure. This makes it possible to produce the nonaqueous electrolyte secondary battery.

### EXAMPLES

### (Physical Properties Measurement/Evaluation Test)

### (1) Average Linear Expansion Coefficient in TD Direction at 30° C. to 50° C.

By a thermomechanical analysis based on JIS K7197, a linear expansion coefficient curve was measured. In the linear expansion coefficient curve, the horizontal axis represents temperatures and the vertical axis represents linear expansion coefficients of a separator. The specific measurement conditions were as follows.
Test device: TMA/SS6100 (Hitachi High-Tech Science Corporation)
Probe diameter: 3.4 mm
Load: 30 mN (tensile load was applied in the TD direction)
Temperature profile: temperature was increased from 30° C. to 150° C. at 10° C./min
Size of test piece: 5 mm (MD direction)×10 mm (TD direction)

From the obtained linear expansion coefficient curve, the TD average linear expansion coefficient was calculated on the basis of the formula below. This formula expresses a value obtained by converting the amount of change in the length of the test piece in the TD direction per degree of temperature, said amount of change being calculated from the gradient of the straight line connecting the respective points on a linear expansion coefficient curve that correspond to 30° C. and 50° C., into the amount of change in the length of the test piece before the test in the TD direction per millimeter of length.

$$TD average linear expansion coefficient [ 1 / K ] = [ \{ L ( {T}_{50} ) - L ( {T}_{30} ) \} / 20 ] / 10$$

L(T₃₀): the amount of change in the length of the test piece in the TD direction at 30° C.
L(T₅₀): the amount of change in the length of the test piece in the TD direction at 50° C.

### (2) Average Linear Expansion Coefficient in MD Direction at 30° C. to 50° C.

In the same manner used for the TD average linear expansion coefficient, the MD average linear expansion coefficient was calculated from the formula below. However, the size of the test piece was changed to 5 mm (TD direction)×10 mm (MD direction). This formula expresses a value obtained by converting the amount of change in the length of the test piece in the MD direction per degree of temperature, said amount of change being calculated from the gradient of the straight line connecting the respective points on a linear expansion coefficient curve that correspond to 30° C. and 50° C., into the amount of change in the length of the test piece before the test in the MD direction per millimeter of length.

$$MD average linear expansion coefficient [ 1 / K ] = [ \{ {L}^{′} ( {T}_{50} ) - {L}^{′} ( {T}_{30} ) \} / 20 ] / 10$$

L′(T₃₀): the amount of change in the length of the test piece in the MD direction at 30° C.
L′(T₅₀): the amount (mm) of change in the length of the test piece in the MD direction at 50° C.
   (3) Discharge Capacity Maintaining Rate after Cycle

A test nonaqueous electrolyte secondary battery which incorporated the separator was produced by the procedure below.
1. A positive electrode which had a thickness of 49.9 μm, a density of 2.97 g/cm³, and a void volume of 24.4 μL was prepared. The composition of the positive electrode active material layer in terms of a weight ratio was LiNi_{0.78}Co_{0.19}Al_{0.03}O₂: electrically conductive material:polyvinylidene fluoride=92:4:4.
2. A negative electrode which had a thickness of 71.2 μm, a density of 1.45 g/cm³, and a void volume of 41.3 μL was prepared. The composition of the negative electrode active material layer in terms of a weight ratio was artificial graphite:styrene butadiene rubber:carboxymethyl cellulose=96.5:2.0:1.5.
3. The negative electrode, the separator, and the positive electrode were formed on top of each other in this order. A nonaqueous electrolyte secondary battery member was thus produced.
4. In a bag including an aluminum layer and a heat-sealing layer that were formed on top of each other, the nonaqueous electrolyte secondary battery member was stored, and a nonaqueous electrolyte was injected. The amount of the nonaqueous electrolyte injected was 2.8 times the total void volume of the electrodes and the laminated separator. The nonaqueous electrolyte was prepared by dissolving 1% by weight of vinylene carbonate and 1 mol/L of LiPF₆ in a mixed solvent having composition of ethylene carbonate: ethyl methyl carbonate:diethyl carbonate=3:5:2 (volume ratio).
5. The bag was heat-sealed while being depressurized. A test nonaqueous electrolyte secondary battery was thus produced.

Next, the discharge capacity of the produced battery was measured according to the following procedure. The discharge capacity maintaining rate was calculated by a comparison between discharge capacities before and after a cycle.
1. Under conditions of temperature: 25° C., voltage range: 2.7 V to 4.2 V, and current value: 0.1 C (during charging) or 0.2 C (during discharging), the initial cycle of charging and discharging was performed. Here, “1C” refers to the value of current in which a rated capacity specified by a discharge capacity based on 1-hour rate is discharged in one hour.
2. The nonaqueous electrolyte secondary battery was aged by performing 10 cycles of charging and discharging under the conditions of temperature: 25° C., voltage range: 2.7 V to 4.2 V, and current value: 1 C (during charging) or 5 C (during discharging).
3. One cycle of charging and discharging was performed under conditions of temperature: 25° C., voltage range: 2.7 V to 4.2 V, and current value: 0.2 C (during charging) or 0.2 C (during discharging).
4. Two hundred cycles of charging and discharging were performed under conditions of temperature: 45° C., voltage range: 2.7 V to 4.2 V, and current value: 1 C (during charging) or 5 C (during discharging). The value obtained by dividing the discharge capacity (mAh) after the cycle(s) by the discharge capacity (mAh) at the first cycle was used as the capacity maintenance ratio after the cycle(s).

### Synthesis Example 1

A coating solution (1) was prepared according to the procedure below. The aramid resin contained in the coating solution (1) is a block copolymer having a poly(4,4′-diphenylsulfonyl terephthalamide) block.
1. A 5 L separable flask having a stirring blade, a thermometer, a nitrogen inflow pipe, and a powder addition port was sufficiently dried.
2. Into the flask, 4177 g of N-methyl-2-pyrrolidone was put. Further, 366.29 g of calcium chloride (dried under vacuum at 200° C. for 2 hours) was put into the flask and the temperature was increased to 100° C. This caused the calcium chloride to dissolve completely, and a calcium chloride solution (8.00% by weight) was obtained accordingly. The water concentration of the calcium chloride solution was adjusted to 300 ppm.
3. With the temperature of the polymerization system maintained at 100° C., 141.119 g of 4,4′-diaminodiphenyl sulfone was added and completely dissolved.
4. The temperature of the polymerization system was cooled to 20° C. With the temperature of the polymerization system maintained at 25±2° C., a total of 226.911 g of terephthaloyl dichloride was added in three separate portions. By one-hour reaction, a block 1 constituted by poly(4,4′-diphenylsulfonyl terephthalamide) was synthesized.
5. Into the flask, 61.460 g of paraphenylene diamine was put into the flask, and caused to dissolve completely over an hour.
6. With the temperature of the polymerization system maintained at 25±2° C., a total of 123.059 g of terephthaloyl dichloride was added in three separate portions. By 1.5-hour reaction, a block 2 constituted by poly(paraphenylene terephthalamide) was elongated on both sides of the block 1.
7. With the temperature of the polymerization system maintained at 20±2° C., the polymerization system was matured for an hour. Then, the air bubbles were removed by stirring under reduced pressure for an hour. An aramid polymerization solution (1) was thus obtained. In the block copolymer included in the aramid polymerization solution (1), the block 1 accounts for 50% of the entire molecule and the block 2 accounts for the remaining 50% of the entire molecule.
8. Alumina (average particle diameter: 13 nm) was added to the aramid polymerization solution (1) and mixing was carried out. In this addition, alumina was added such that the weight ratio between the aramid resin and the alumina was 1:1.
9. The mixed solution obtained in step 8 was diluted with N-methyl-2-pyrrolidone such that the solid content was 6% by weight, and then stirred for 240 minutes. The term “solid content” here means the total weight of the aramid resin and the alumina.
10. By adding calcium carbonate to the mixed solution obtained in step 9, and then performing stirring for 240 minutes, the solution was neutralized. This neutralized solution was defoamed under reduced pressure, and a coating solution (1) in slurry form was thus prepared.

### Example 1

A nonaqueous electrolyte secondary battery laminated separator was produced by the procedure below. The separator was produced while an original sheet of the polyolefin porous film was conveyed by machine.
1. A coating solution (1) was applied on one surface of the polyolefin porous film (polyethylene porous film, film thickness: 12 μm, basis weight: 7.0 g/m²). This formed a coated film of the coating solution (1).
2. The polyolefin porous film was introduced into a precipitation bath which was adjusted to a temperature of 50° C. and a relative humidity of 70%. A block copolymer was precipitated by bringing water vapor and the coated film into contact with each other.
3. The coating solution (1) was applied to a surface of the polyolefin porous film on the opposite side from the one surface, on which the coating solution (1) was applied in step 1. This formed a coated film of the coating solution (1).
4. The polyolefin porous film was introduced into an immersion bath filled with a mixed solution having an ion-exchange water: NMP weight ratio of 2:3. A block copolymer was precipitated by bringing the mixed solution and the coated film into contact with each other.
5. The polyolefin porous film, on both surfaces of which a porous layer containing the block copolymer was formed, was washed with water. This removed the calcium chloride and the N-methyl-2-pyrrolidone.
6. The polyolefin porous film, on both surfaces of which the porous layer containing the block copolymer was formed, was dried.
7. With use of a tenter, the polyolefin porous film was stretched in the TD direction. The stretching conditions were a temperature in a pre-heating chamber of 50° C., a temperature in a stretching chamber of 60° C., a temperature in a heat-fixing chamber of 133° C., and a stretch ratio of 14%. A separator (1) was thus obtained.

### Examples 2 to 4, Comparative Example 1

The stretching condition and contraction condition in step 7 of Example 1 were changed as described in Table 1. In Example 4, the polyolefin porous film was contracted in the TD direction in the heat-fixing chamber. Separators (2) to (4) and comparative separator (1) were thus obtained.

### [Results]

The results are shown in Table 1.

TABLE 1

| | TD | TD | TD average linear | MD average linear | Discharge capacity |
|---|---|---|---|---|---|
| | stretching | contraction | expansion coefficient | expansion coefficient | maintaining rate |
| | ratio (%) | ratio (%) | (×10⁻⁶ · l/K) | (×10⁻⁶ · l/K) | after cycle (%) |
| Example 1 | 14 | 0 | 48.0 | 72.6 | 95 |
| Example 2 | 12 | 0 | 24.6 | 16.8 | 88 |
| Example 3 | 2 | 0 | 10.3 | −6.2 | 88 |
| Example 4 | 12 | 4 | 193.0 | 17.6 | 87 |
| Comparative | 0 | 0 | 0.3 | −17.3 | 83 |
| Example 1 | | | | | |

It has been shown from Table 1 that there is a correlation between the TD average linear expansion coefficient and the capacity maintenance ratio after the cycle. The separators in accordance with Examples had TD average linear expansion coefficients of not less than 3.0×10⁻⁶ [1/K], and had capacity maintenance ratios after 200 cycles as high as not less than 85%. The separator in accordance with Comparative Example had a TD average linear expansion coefficient of less than 3.0×10.6 [1/K], and had a capacity maintenance ratio after 200 cycles as low as less than 85%.

From the results of Examples and Comparative Examples, it has been shown that the following two factors affect the TD average linear expansion coefficient.
Stretch ratio of TD stretching: When the stretch ratio of the TD stretching after formation of a porous layer is greater, the TD average linear expansion coefficient tends to be greater (see Examples 1 to 3).
Performing TD contraction: When the TD stretching was performed after formation of a porous layer and the TD contraction is further performed thereafter, the TD average linear expansion coefficient tends to be greater (see Examples 1 and 4).

### INDUSTRIAL APPLICABILITY

The present invention can be used in, for example, a nonaqueous electrolyte secondary battery.

1. A nonaqueous electrolyte secondary battery laminated separator, comprising:
a polyolefin porous film and a porous layer, the porous layer being formed on one surface or both surfaces of the polyolefin porous film,
the nonaqueous electrolyte secondary battery laminated separator having an average linear expansion coefficient of not less than 3.0×10⁻⁶ [1/K] in a TD direction at 30° C. to 50° C.

2. The nonaqueous electrolyte secondary battery laminated separator according to claim 1, wherein
the nonaqueous electrolyte secondary battery laminated separator has an average linear expansion coefficient of not less than-8.0×10⁻⁶ [1/K] in an MD direction at 30° C. to 50° C.

3. The nonaqueous electrolyte secondary battery laminated separator according to claim 1, wherein
the porous layer includes a filler, and
the filler is an inorganic filler and/or an organic filler.

4. The nonaqueous electrolyte secondary battery laminated separator according to claim 3, wherein
with respect to 100% by weight of the porous layer, the filler is contained in an amount of 30% by weight to 99% by weight.

5. The nonaqueous electrolyte secondary battery laminated separator according to claim 1, wherein
the porous layer includes at least one resin selected from the group consisting of polyolefins, (meth)acrylate-based resins, fluorine-containing resins, polyamide-based resins, polyimide-based resins, polyamide-imide-based resins, polyester-based resins, and water-soluble polymers.

6. The nonaqueous electrolyte secondary battery laminated separator according to claim 5, wherein
the porous layer includes an aramid resin.

7. A nonaqueous electrolyte secondary battery member, comprising
a positive electrode, the nonaqueous electrolyte secondary battery laminated separator according to claim 1, and a negative electrode which are formed on top of each other in this order.

8. A nonaqueous electrolyte secondary battery, comprising
the nonaqueous electrolyte secondary battery laminated separator according to claim 1.

9. A nonaqueous electrolyte secondary battery, comprising
the nonaqueous electrolyte secondary battery member according to claim 7.
